(19) United States
(12) Patent Application Publication
(10) Pub. No.: US 2004/0011342 A1
(43) Pub. Date: Jan. 22, 2004

(54) Electronic device for internal combustion engine such as ignition device

(75) Inventor: Katsuaki Fukatsu, Hitachinaka-shi (JP)

Correspondence Address: CROWELL & MORING LLP, INTELLECTUAL PROPERTY GROUP, P.O. BOX 14300, WASHINGTON, DC, 20044-4300, US

(73) Assignees: HITACHI, LTD.; HITACHI CAR ENGINEERING CO., LTD.

(21) Appl. No.: 10/610,824

(22) Filed: Jul. 2, 2003

(30) Foreign Application Priority Data
Jul. 2, 2002 (JP) 2002-193104

(51) Int. Cl. F02P 11/00

(52) U.S. Cl. 123/630; 123/644

(57) ABSTRACT

The present invention is directed to prevent abnormal increase in temperature of an IGBT of an ignition device or the like caused by rise in a low-level signal, while maintaining small size and formation of the IGBT, a thermal shutoff circuit, a current limiting circuit, and the like on one chip. An ignition device for an internal combustion engine is provided with a shutoff circuit for forcedly shutting off passage of a current to an ignition switching element (IGBT) when abnormal increase in temperature of the IGBT is detected or the high level of an ignition signal continues for predetermined time or longer. As a power source of the shutoff circuit, a high-level voltage of the ignition signal is used. Until the voltage of the ignition signal becomes the level at which the shutoff circuit operates, agate of the IGBT is short-circuited to the ground by an operation level setting circuit. Thus, the IGBT has a dead zone of the ignition signal.

### FIELD OF THE INVENTION

The present invention relates to an electronic device for an internal combustion engine and, more particularly, to an electronic device using an insulated gate semiconductor element such as an IGBT (Insulated Gate Bipolar Transistor) as a switching element like an ignition device.

### BACKGROUND OF THE INVENTION

For example, in an ignition device for an internal combustion engine, an IGBT is used as a switching element for controlling energization (passage)/shut-off (interruption) of a primary current of an ignition coil.

Japanese Patent Laid-Open No. H8(1996)-338350 discloses a technique of integrating, by a semiconductor into a one chip, a switching element (IGBT) of an ignition coil, a current detecting circuit for detecting a primary current of the ignition coil, a current limiting circuit for limiting the primary current to a preset value by controlling a gate voltage on the basis of the primary current detected by the current detecting circuit, and a thermal shut-off circuit for forcedly shutting off the primary current by short-circuiting an ignition signal (gate voltage) to the ground (GND) when temperature is detected and the detected temperature becomes predetermined temperature or higher.

In the prior art, the thermal shut-off circuit detects the temperature of the IGBT via the temperature of the chip and, when the temperature of the IGBT becomes equal to or higher than predetermined temperature, forcedly shuts off the primary current of the ignition coil, thereby preventing abnormal heat generation in the IGBT and preventing the IGBT from being destroyed by heat. The thermal shut-off circuit can prevent abnormal heat generation caused by continuous passage of a current to the IGBT or by a dump surge.

In the prior art, the thermal shut-off circuit and the current limiting circuit are connected in parallel between an electric line, which connects an input terminal of an ignition signal and the gate of the IGBT, and the ground. Thereby the ignition signal is used as a circuit power source.

Japanese Patent Laid-Open No. 2001-193617 discloses a self shut-off circuit with a timer for counting ON-state time of an ignition signal. In this timer type self shut-off circuit, when the ignition signal is at the high level for predetermined time or longer, the ignition signal (gate voltage) is short-circuited to the ground GND to forcedly shut off the primary current. In the publication, a one-chip ignition device is also proposed, which is constructed by integrating the self shut-off circuit on a silicon substrate together with an IGBT, an input control circuit for controlling the gate voltage of the IGBT, and a current limiting circuit for preventing excessive primary current.

The cause of heat generation in the electronic device such as an ignition device is not limited to abnormally long energizing time of the IGBT but the above-described dump surge and application of a high load to the IGBT due to short circuit of the ignition coil, layer short, GND short of a harness or the like, and so on may be considered.

In such a case as well, to protect the IGBT, it is desirable to use the thermal shut-off circuit performing thermal detection. Since the thermal detection is performed via a chip, as described in Japanese Patent Laid-Open No. H8(1996)-338350, it is necessary to integrate an IGBT as a heat generation source and a thermal shut-off circuit having a thermal detection function on one chip.

In the case of using a voltage of an ignition signal (voltage of a high-level signal) as a power source of various circuits of the ignition device as described in Japanese Unexamined Patent Publication No. 8-338350, a dedicated power source terminal is not provided, that is, an input terminal of the ignition signal also serves as the power source terminal. Thus, an intelligent one chip of an IGBT and a control circuit can be realized for the following reason. In the case of using a power source such as a battery power source for a power source circuit of the ignition device, the number of power source terminals increases and, moreover, protection has to be provided against a surge and the breakdown voltage of the device has to be increased, so that the size of the chip becomes large. To form a capacitor and the like of the power source circuit, a large-scale space is required. Consequently, it is actually impossible to integrate the components on one chip. In contrast, in the case where a dedicated power source terminal is not provided as described above, such a problem does not occur.

In addition to the various causes of heat generation in the IGBT, there is another cause of so-called rise in a voltage, to be specific, rise in the low level of an ignition signal due to a potential difference of ground (GND) between an engine control unit (ECU), which generates and outputs an ignition signal, and the ignition device.

When the low level of an ignition signal rises due to such a voltage level rise phenomenon, there is a case such that a low-level signal reaches the operation voltage of the IGBT and is applied to the gate of the IGBT, thereby starting passage of a primary current to the ignition coil. Since the value of the collector current or primary current of the IGBT is controlled by the gate voltage, with a low voltage of the degree of the rise of the low level in the ignition signal, the primary low current flows. Even in such a mode, the IGBT has the potential of heat generation and thermal destruction, so that the problem has to be dealt with.

Even when the electronic device such as an ignition device has a thermal shutoff circuit, it is difficult to prevent abnormal heat generation in the IGBT caused by the voltage level rise phenomenon for the following reason. Since the voltage at the time when the low level of a control signal rises is generally lower than the power source for driving the thermal shutoff circuit, the thermal shutoff circuit cannot function when heat generation occurs due to the rise in the low level. Particularly, in the case of using an ignition signal (of the high level) as a drive power source of the thermal shutoff circuit, it is difficult to prevent the rise in the voltage level.

### SUMMARY OF THE INVENTION

An object of the present invention is to provide an electronic device for an internal combustion engine such as an ignition device capable of preventing abnormal heat generation in an IGBT due to rise in a low-level signal and maintaining soundness of an IC (Integrated Circuit) chip of this kind, while maintaining small size and formation of one chip of an IGBT, a thermal shutoff circuit, a current limiting circuit, and the like of an electronic device such as an ignition device.

According to the invention, to achieve the object, basically, in an electronic device for an internal combustion engine having an insulated gate semiconductor element such as an IGBT which is driven by receiving a control signal such as an ignition signal, a dead zone is set in the IGBT with respect to a voltage value of a control signal.

The dead zone denotes here a gate voltage region in which the IGBT is prevented from operating even at an operation level. The IGBT is allowed to operate at a predetermined level (for example, the high level of the ignition signal).

With the configuration, for example, in the case of using the high-level voltage of a control signal (such as an ignition signal in the case of an ignition device) as a power source for operating a protection circuit such as a thermal shutoff circuit, until the voltage of the control signal reaches the level at which the shutoff circuit can operate, the insulated gate semiconductor element is in the dead zone. Consequently, a situation such that a current is made to pass to the insulated gate semiconductor element due to rise in the low level of the control signal can be prevented. Therefore, even when thermal shutoff or the like does not function, abnormal heat generation in the insulated gate semiconductor can be prevented.

Such a dead zone can be achieved by short-circuiting the gate of the insulated gate semiconductor device to the ground until the shutoff circuit operates.

If the gate voltage level at which the insulated gate semiconductor element can operate (voltage exceeding the dead zone), which is set by an operation level setting circuit, is set to be equal to or lower than a necessary power source voltage of the shutoff circuit, even though the ignition signal reaches the voltage level at which the insulated gate semiconductor element operates, a mode in which the shutoff circuit does not operate occurs. To deal with the problem, it is set to satisfy the relation of “operation level set voltage >shutoff circuit operation voltage range”. In such a manner, when the ignition signal reaches the operation level of the IGBT, the thermal shutoff circuit operates without fail. Since the operation level setting circuit and the shutoff circuit use the high level range of the ignition signal as a circuit power source, they cannot be set in series to the line from the ignition signal input part to the gate of the IGBT. The reason is that the voltage of circuit drive and a reference signal used for comparing with become the same. In the invention, by connecting the operation level setting circuit and the shutoff circuit in parallel between the line extending from the ignition signal input to the gate of the IGBT and the ground GND, the configuration of the circuit can be satisfied.

By using the high-level signal of the ignition signal as the power source of the operation level setting circuit and the shutoff circuit, a dedicated power source terminal is no more required. In the case of forming the insulated gate semiconductor element, operation level setting circuit, shutoff circuit, and the like on one chip, only three terminals of a signal input terminal, a collector terminal, and a GND terminal are provided. Thus, the size of an ignition device assembly can be reduced.

### BRIEF DESCRIPTION OF THE DRAWINGS

FIG. 1 is a block circuit diagram and its partial circuit diagram of an ignition device according to an embodiment of the invention.

FIG. 2 is a diagram showing an operation waveform of the embodiment.

FIG. 3 is a graph showing a control operation of the embodiment.

FIG. 4 is a diagram showing a concrete example of the circuit configuration of the embodiment.

FIG. 5 is a plan view showing an assembly of the ignition device of the embodiment.

FIG. 6 is a plan view and a partial cross section showing a state where the assembly is built in an ignition coil device.

FIG. 7 is a circuit diagram showing a second embodiment of the invention.

### DETAILED DESCRIPTION OF THE PREFERRED EMBODIMENTS

An embodiment of the invention will be described hereinbelow with reference to the drawings.

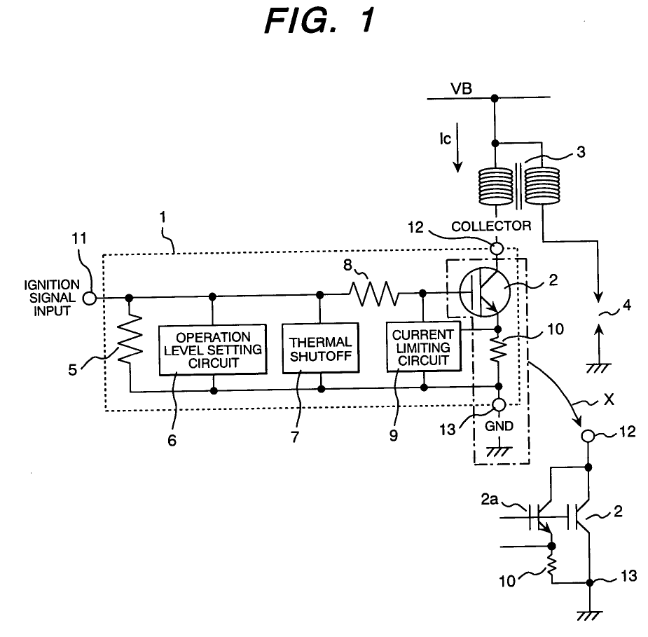

FIG. 1 is a block diagram showing an electronic device according to an embodiment of the invention. As the electronic device, an ignition device for an internal combustion engine is illustrated.

An ignition device 1 has: a switching element 2 for an ignition coil 3 which drives on receipt of an ignition signal (control signal) from a not-shown engine control unit (hereinbelow, called “ECU”); a current limiting circuit 9 for detecting a current (primary current) made to pass to a primary winding of the ignition coil 3 and controlling the switching element 2 so that the current does not become equal to or larger than a predetermined value; a thermal shutoff circuit 7 for detecting abnormal heat generation in the switching element 2 and forcedly shutting off passage of current to the switching element 2; and an operation level setting circuit 6 for setting a dead zone in the switching element 2 with respect to a voltage value of the ignition signal. An example of a concrete and detailed circuit of the operation level setting circuit 6 and the thermal shutoff circuit 7 will be described hereinlater. As the switching element 2, for example, an IGBT is used. The switching element in the embodiment will be called an IGBT hereinbelow.

The IGBT 2, current limiting circuit 9, thermal shutoff circuit 7, operation level setting circuit 6, and resistors 5, 8, and 10 constructing the ignition device 1 are formed on one chip by a semiconductor (silicon) integrated circuit.

Between a line extending from an input terminal 11 of the ignition device 1 to the gate of the IBGT 2 and the ground GND, the operation level setting circuit 6, thermal shutoff circuit 7, and current limiting circuit 9 are connected in parallel. As the power source of those circuits, a voltage of a high level signal of an ignition signal is used.

The collector of the IGBT 2 is connected to the primary winding of the ignition coil 3 and the emitter is connected to the ground GND. The other end of the primary winding is connected to a battery power source VB and the low-voltage side of a secondary winding.

The resistor 10 for detecting the primary current of the ignition coil 3 is, as shown in a partially enlarged view indicated by a leader line X, actually connected between the collector of a sense IGBT 2a and the ground GND. The sense IGBT 2a is connected between the collector of the main IBGT 2 as a switching element and the ground GND.

An ignition signal received from the input terminal 11 of the ignition device 1 is a pulse signal having a high level and a low level.

The ignition signal is input to the gate of the IGBT 2 through the resistor 8 and, by the high level signal of the ignition signal, a current is made to pass between the collector and the emitter of the IGBT 2 (ON). When the IGBT 2 is turned on, a primary current Ic passes to the primary winding of the ignition coil 3. By the low level signal of the ignition signal, the IGBT 2 is shut off (OFF). At the timing of the shutoff, a voltage of hundreds V is induced to the collector. A high voltage of tens KV is generated in the secondary winding of the ignition coil 3 and an ignition plug 4 is discharged.

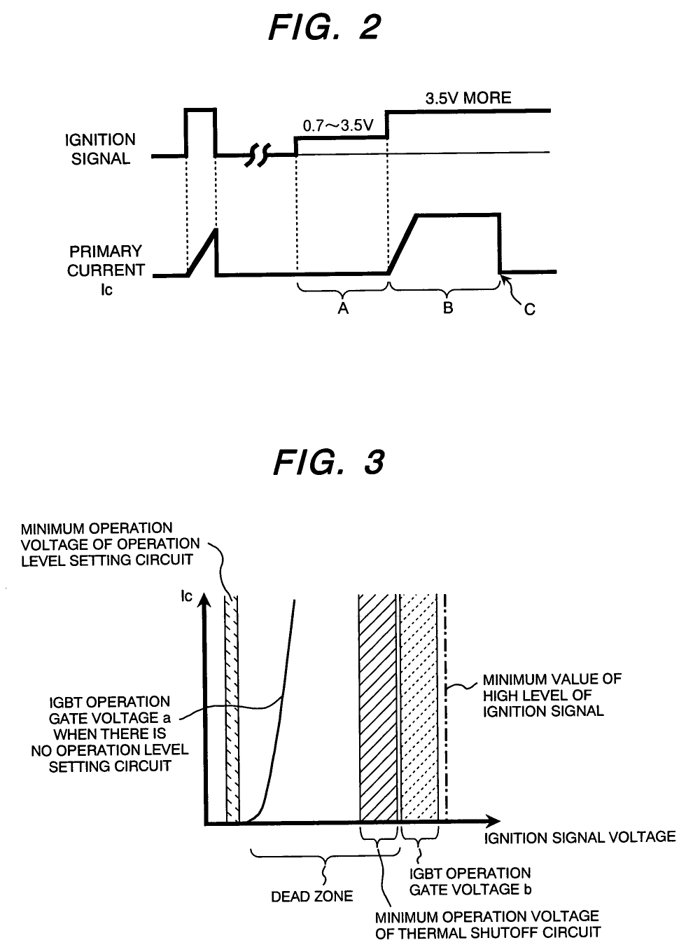

The circuit operation of the ignition device 1 will now be described with reference to FIG. 2.

In the embodiment, input conditions of an ignition signal from the ECU are that the maximum value MAX of the low-level signal is lower than 0.7V and the minimum value MIN of the high-level signal is 3.5V or higher.

In FIG. 2, in a range A, the ignition signal is continuously in a range from 0.7V to a voltage lower than 3.5V.

It is assumed that the ignition signal lies in the range A in any of the case where the low-level signal rises in a normal current-passage state and the case where the voltage of the high-level signal decreases in a state where the ignition signal is continuously made to pass. The range A is set by the operation level setting circuit 6 so as to be the dead zone of the IGBT 2.

The dead zone is a zone (range) of a gate voltage having a level at which the current can be made to pass to the IGBT 2 if there is no operation level setting circuit 6. In the dead zone, however, the gate voltage is forcedly set by the operation level setting circuit 6 so that no current is made to pass to the IGBT 2.

When the ignition signal lies in the range A, the operation level setting circuit 6 sets the IGBT 2 so as to be in the dead zone by short-circuiting the gate of the IGBT 2 to the ground GND. Therefore, no primary current is generated in the dead zone mode.

In a range B, a high-level signal of 3.5V or higher is continued. In this case, the primary current Ic reaches a saturated current value and is continuously made to pass, so that the IGBT 2 generates heat abnormally. The thermal shutoff circuit 7 functions as follows by using the voltage of the high-level signal of the ignition signal as a power source. The shutoff circuit 7 detects the temperature of the IGBT 2 via the chip. When the detected temperature reaches an abnormal level, the shutoff circuit 7 short-circuits the gate of the IGBT 2, thereby forcedly shutting off passage of current to the IGBT 2. The timing is indicated by a point C.

FIG. 3 shows the relations among: a gate voltage characteristic at which a current can be made to pass to the IGBT 2 when there is no operation level setting circuit 6 (hereinbelow, called “IGBT operation gate voltage a”); a dead zone which is set by the operation level setting circuit 6; a minimum value of the gate voltage at which a current can be made to pass to the IGBT 2 which is set by the operation level setting circuit 6 (hereinbelow, called “IGBT operation gate voltage b”; the minimum voltage required to drive the operation level setting circuit 6 (hereinbelow, called “minimum operation voltage of the operation level setting circuit”); a minimum voltage required to drive the thermal shutoff circuit 7 (hereinbelow, called “minimum operation voltage of the thermal shutoff circuit”); and the minimum value of the high level of the ignition signal (hereinbelow, called “minimum value of the high level of the input ignition signal”).

The IGBT operation gate voltage “a” is about 0.7V, the IGBT operation gate voltage “b” is about 3.5V, the minimum operation voltage of the operation level setting circuit is set to be lower than the IGBT operation gate voltage “a” (0.7V or lower), and the minimum operation voltage of the thermal shutoff circuit is set to be slightly lower than the IGBT operation gate voltage “b”. Each of the set voltages has some margin due to variations in the characteristics.

Because of necessity of setting the dead zone (gate voltage from 0.7V to 3.5V) in the IGBT 2, the operation level setting circuit 6 has to certainly operate at a voltage equal to or lower than the IGBT operation gate voltage “a”. The thermal shutoff circuit 7 has to operate without fail when a current is made to pass to the IGBT 2. For the above reasons, the voltages are set so as to satisfy the relations of the minimum operation voltage of the operation level setting circuit <minimum operation voltage of the thermal shutoff circuit <the IGBT operation gate voltage “b”.

By setting the voltages in such a manner, when a potential difference occurs in the ground level between the ECU and the ignition device and the low level of the ignition signal rises (the state A in FIG. 2), even when the thermal shutoff circuit 7 is not yet functioning, the passage of a current to the IGBT 2 is checked by the dead zone setting operation of the operation level setting circuit 6. As a result, a phenomenon in which abnormal heat is generated in the IGBT 2 and the IGBT 2 is destroyed can be prevented. When the IGBT 2 reaches the level at which a current is made to pass at the high-level of the ignition signal, the thermal shutoff circuit 7 is always in an operable state. Consequently, even when the high level of the ignition signal continues and the temperature of the IGBT abnormally increases, the passage of a current to the IGBT can be forcedly shut off before the IGBT is destroyed by heat.

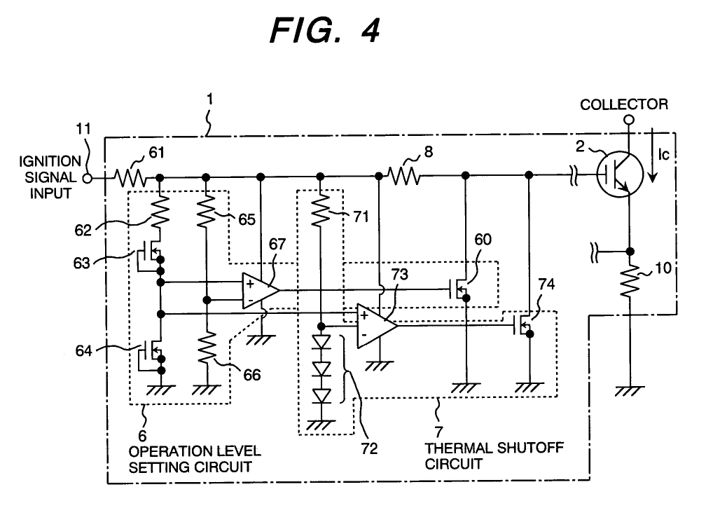

FIG. 4 shows an example of a concrete circuit configuration of the ignition device in the embodiment. Since the current limiting circuit 9 has a conventionally known configuration, it is not shown.

In FIG. 4, the operation level setting circuit 6 is constructed by MOSFETs 63, 64, and 60, a comparator 67, and resistors 62, 65, and 66. By a line extending from the input terminal 11 of the ignition signal via a resistor 61, the power source is led to the comparator 67. The resistor 62 and MOSFETs 63 and 64 are connected between the ignition signal line and the GND line, and the connection point of the MOSFETs 63 and 64 is connected to a non-inversion terminal of the comparator 67.

To an inversion terminal of the comparator 67, a voltage obtained by dividing the voltage of the ignition signal line by the resistors 65 and 66 is supplied. When the voltage of the ignition signal becomes a predetermined value or higher, the MOSFETs 63 and 64 clamp a predetermined voltage, and the predetermined voltage is input as a reference voltage to the non-inversion terminal of the comparator 67.

On the other hand, the input voltage of the inversion terminal which is divided by the resistors 65 and 66 changes interlockingly with the ignition signal voltage.

An output terminal of the comparator 67 is connected to the gate of the MOSFET 60. Until the voltage of the inversion terminal of the comparator 67 exceeds the voltage of the non-inversion terminal (until the voltage exceeds the dead zone), the MOSFET 60 is ON to short-circuit the gate voltage of the IGBT 2 to the ground GND.

The ignition signal line is divided by the resistor 8 into the circuit power source of the ignition device and the gate control line of the IGBT 2.

The thermal shutoff circuit 7 is constructed by a resistor 71, a diode 72 for detecting temperature, a comparator 73, and a MOSFET 74.

Between the ignition signal line after the resistor 61 and the ground GND, the diode 72 for detecting temperature is connected via the resistor 71. The temperature of the chip to which the heat of the IGBT 2 is conducted is detected by using the temperature characteristic of a voltage drop VF in the forward direction of the diode 72. The detected voltage is input to the inversion terminal of the comparator 73, and the reference voltage used in the operation level setting circuit 6 is input to the non-inversion terminal of the comparator 73.

When the detected voltage becomes below the reference voltage (abnormal temperature generation detected state), the MOSFET 74 is turned on by an output of the comparator 73, the gate voltage of the IGBT 2 is short-circuited to the ground, and the IGBT 2 is turned off.

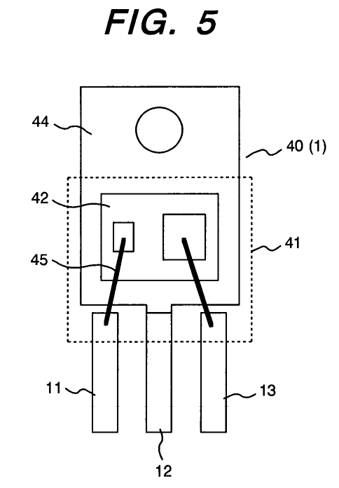

FIG. 5 shows an assembly 40 of the ignition device 1 according to the embodiment. Reference numeral 42 denotes an intelligent IGBT chip of a one-chip type formed by integrating the IGBT 2 together with the current limiting circuit 9, operation level setting circuit 6, and thermal shutoff circuit 7. The chip 42 is bonded to a metal frame 44 made of Cu, Al or the like having an integrated external terminal (collector terminal 12) via solder, for example, an Sn/Sb-based, Pb/Sn-based, or Sn—Ag based solder so as to be electrically conductive. The frame 44 serves as a collector electrode having the same potential as that of the rear face (collector) of the IGBT 2.

The input terminal 11 of the ignition signal and a GND terminal 13 are connected to surface electrodes of the chip 42 via wires 45 made of Al or the like. The connection is, for example, ultrasonic connection. The major portion or part of the ignition device assembly except for the terminals is transfer-molded by using an epoxy resin 41 having a coefficient of linear expansion of 30×10⁻⁶ or less.

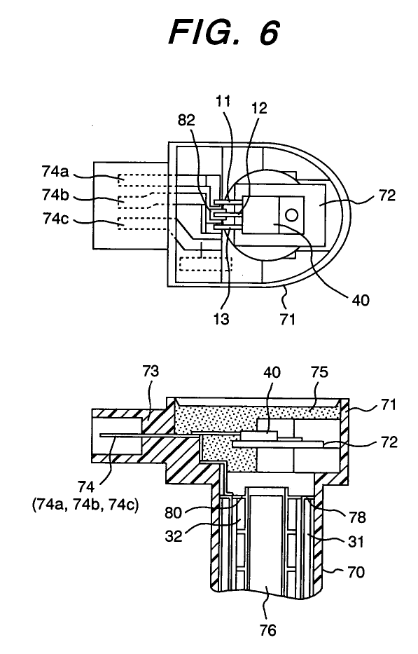

FIG. 6 is a plan view and a partial cross section showing a mounting state where the ignition device assembly 40 is mounted in the ignition coil.

The assembly 40 is built in the ignition coil by being bonded to a heat sink 72 and positioned to an igniter case 71 provided on an ignition coil case 70. The igniter case 71 is made of a resin and molded integrally with a connector case 73. Terminals 74 (an ignition signal terminal 74a, a GND terminal 74b, and a power source terminal VB) are insert-molded in the igniter case 71 or press-fitted to the igniter case 71 after forming the case by using a resin. In the coil case 70, a core 76, a secondary bobbin 80 around which a secondary winding 32 is wound, and a primary bobbin 78 around which a primary winding 31 is wound are assembled before the ignition device assembly 40 is attached.

After attaching the ignition device assembly 40 to the igniter case 71, terminals 11 to 13 of the ignition device are connected to a terminal 82 relaying to the coil terminals 74 and the coil winding portion by welding or soldering. After attaching the ignition device assembly 40, the ignition coil is filled with an insulating epoxy resin 75 which is hardened.

According to the embodiment, the problem such that the IGBT is destroyed by heat due to a short circuit in the ignition coil, continuous input of the current passage signal from the ECU, or the like can be prevented. Abnormal increase in the temperature in the continuous current passage mode at a low voltage due to the rise in the low level of the ignition signal from the ECU (which occurs due to a potential difference caused by different earth points between the ignition device and the ECU) can be also prevented. Since the ignition input signal voltage from the ECU is used as the circuit power source of the operation level setting circuit and the thermal shutoff circuit, the circuit can be constructed without using the power source terminal as the ignition device. As a result, a multi-function ignition device having three terminals can be constructed. With the configuration, wiring of the connection part and the power source can be omitted, assembling to the ignition coil is facilitated, andprotection for the power source line as a circuit of the ignition device becomes unnecessary. Thus, reduction in size and cost can be achieved. More than that, because of one chip configuration of the semiconductor, as compared with an ignition device obtained by usually constructing the chip of a single IGBT and a control circuit portion by a hybrid substrate, the number of parts and the number of connection points are smaller, and lower cost and higher reliability can be assured.

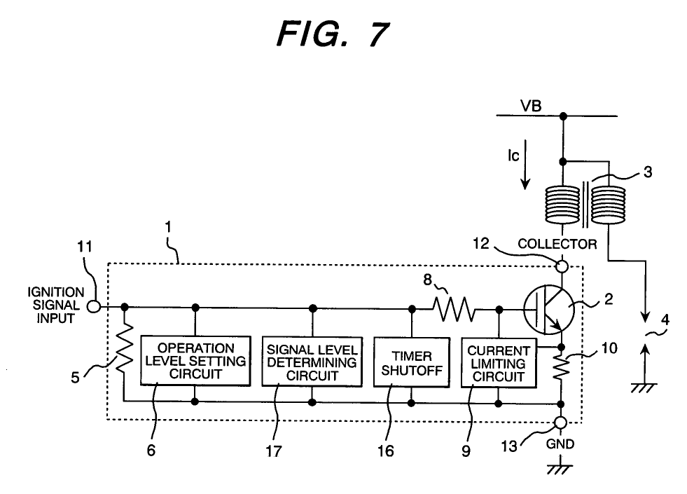

Although the combination of the thermal shutoff circuit 7 and the operation level setting circuit (dead zone setting means) 6 is illustrated in the embodiment, as shown in FIG. 7, instead of the thermal shutoff circuit, the operation level setting circuit 6 and a shutoff circuit 16 with a timer may be combined. The shutoff circuit 16 with timer and a signal level determining circuit 17 related to the circuit 16 are connected in parallel together with the operation level setting circuit 6 and the current limiting circuit 9 between the line extending from the ignition signal input terminal to the gate and the ground GND, and use a high-level signal of the ignition signal as a circuit power source.

In this case, the dead zone of the ignition signal of the IGBT 2 is set by the operation level setting circuit 6 and, when a high-level signal exceeding the dead zone is input, the shutoff circuit 16 with timer operates. When the signal level determining circuit 17 determines that the ignition signal from the ECU becomes a high-level signal, the shutoff circuit 16 with timer counts time of the high-level signal. When the period of the high level becomes abnormally longer than normal energizing time, the shutoff circuit 16 with timer short-circuits the gate of the IGBT 2 to the ground GND via the switching element, thereby forcedly shutting off the passage of current to the IGBT 2. In this case as well, the control circuits such as the IGBT 2, operation level setting circuit 6, signal level determining circuit 17, shutoff circuit 16 with timer, and current limiting circuit 9 are formed in one chip having a structure of three terminals similar to that in FIG. 5.

The invention is not limited to the ignition device but can be also applied to an electronic device such as various actuators used for engine controls.

According to the invention, while maintaining small size and formation of the IGBT, thermal shutoff circuit, current limiting circuit, and the like of the electronic device such as an ignition device in one chip, the IGBT can be prevented from being destroyed by heat due to a short-circuit in the ignition coil, continuously input of the current passage signal from the ECU, or the like. Moreover, the temperature of the IGBT can be prevented from being abnormally increased by rise in the low-level signal. Thus, the soundness of the IC chip of this kind can be maintained more reliably.

What is claimed is:

1. An electronic device for an internal combustion engine having an insulated gate semiconductor element which is driven by receiving a control signal, comprising:
an operation level setting circuit for setting a dead zone in said insulated gate semiconductor device with respect to a voltage value of an input control signal; and
a shutoff circuit for forcedly shutting off passage of a current to the insulated gate semiconductor element when abnormal increase in temperature of said insulated gate semiconductor element is detected or time of passage of a current to said insulated gate semiconductor element becomes predetermined time or longer.

2. The electronic device for an internal combustion engine according to claim 1, wherein said operation level setting circuit and said shutoff circuit are connected in parallel between a line extending from an input terminal of said control signal to a gate of said insulated gate semiconductor element and a ground, and said control signal is used as a power source of the circuits.

3. An electronic device for an internal combustion engine, comprising:
an insulated gate semiconductor element which receives a pulse control signal generated by a low-level voltage and a high-level voltage and is turned on at the time of the high level; and
a shutoff circuit for forcedly shutting off passage of a current to the insulated gate semiconductor element when abnormal increase in temperature of a switching element of said insulated gate semiconductor element is detected or the high level of said control signal continues for predetermined time or longer,
wherein a high-level voltage of said control signal is used as a power source for operating said shutoff circuit,
an operation level setting circuit for short-circuiting a gate of said insulated gate semiconductor element to the ground is provided until the voltage of said control signal becomes an operation voltage of said shutoff circuit, and
a dead zone of said control signal is set in said insulated gate semiconductor element by the operation level setting circuit.

4. The electronic device for an internal combustion engine according to claim 3, wherein said insulated gate semiconductor element is an insulated gate bipolar transistor (hereinbelow, abbreviated as “IGBT”), said IGBT, said shutoff circuit, and said operation level setting circuit are formed so as to be integrated on one chip, terminals of the one chip are an input terminal to which said control signal is input, a collector terminal of said IGBT, and a ground terminal, and a dedicated power source terminal is not provided.

5. The electronic device for an internal combustion engine according to claim 3, wherein a minimum voltage level of a power source for operating said shutoff circuit is set to be equal to or lower than a gate voltage level which is set by said operation level setting circuit so that said IGBT can operate and, when said IGBT operates by the high-level signal of the control signal, said shutoff circuit is allowed to always function.

6. The electronic device for an internal combustion engine according to claim 1 or 3, wherein said shutoff circuit is either a thermal shutoff circuit for short-circuiting a gate voltage of said IGBT to the ground when abnormal increase in temperature of said IGBT is detected, or a shutoff circuit with a timer for short-circuiting the gate voltage of said IGBT to the ground when a gate signal of a predetermined level of said IGBT or higher continues for predetermined time or longer.

7. An ignition device for an internal combustion engine, which controls passage/shut-off of a primary current made to pass to an ignition coil by a switching element in accordance with an ignition signal output from a controller, thereby makes a high voltage generated on a secondary side of said ignition coil, and said switching element being an insulated gate semiconductor element,
wherein a gate of said switching element is short-circuited to the ground until the level of said ignition signal reaches a normal high level at which a current is made to pass to said switching element, thereby preventing the passage of current to said switching element caused by a rise in the low level.

8. An ignition device for an internal combustion engine, which controls passage/shut-off of a primary current made to pass to an ignition coil by a switching element in accordance with an ignition signal output from a controller, thereby makes a high voltage generated on a secondary side of said ignition coil, and said switching element being an insulated gate semiconductor element,
comprising a shutoff circuit for forcedly shutting off passage of a current to the switching element when abnormal increase in temperature of said switching element is detected or a high level of said ignition signal continues for predetermined time or longer; the high-level voltage of said ignition signal being used as a power source for operating the shutoff circuit; and
an operation level setting circuit for short-circuiting a gate of said switching element to the ground until the voltage of said ignition signal reaches the level at which said shutoff circuit operates, and setting a dead zone of said ignition signal in said switching element.

9. The ignition device for an internal combustion engine according to claim 8, wherein said switching element is an IGBT,
said IGBT, a current limiting circuit for detecting a primary current of an ignition coil and controlling a gate voltage of said IGBT so that the primary current does not exceed a predetermined value, said shutoff circuit and said operation level setting circuit are integrated and formed on one chip, and
terminals of the one chip are three terminals of an input terminal to which said ignition signal is input, a collector terminal connected to a primary winding of said ignition coil, and a ground terminal.
